(19) United States
(12) Patent Application Publication
(10) Pub. No.: US 2024/0170233 A1
(43) Pub. Date: May 23, 2024

(54) HIGH CURRENT THERMOSTAT

(71) Applicant: THERM-O-DISC, INCORPORATED, Mansfield, OH (US)

(72) Inventors: Changcai ZHAO, Zhuhai (CN); William SUEN, Zhuhai (CN); Parsons PAN, Zhuhai (CN)

(21) Appl. No.: 18/284,006

(22) PCT Filed: Mar. 18, 2022
(86) PCT No.: PCT/US2022/020970

§ 371 Date: Sep. 25, 2023

(30) Foreign Application Priority Data
Mar. 23, 2021 (CN) 202120586599.7

(51) Int. Cl. H01H 1/58; H01H 37/04

(52) U.S. Cl. CPC H01H 1/58; H01H 37/04

(57) ABSTRACT

The disclosure provides a construction for a high-current thermostat including a thermostat housing, a rivet hole arranged in the thermostat housing, and a rivet matched with the rivet hole. The terminal is connected to the thermostat housing by the rivet. The rivet hole and rivet each have a polygonal shape and the rivet can be solid. The terminal includes a multi-layered metal structure. The polygonal-shaped rivet hole and solid rivet improve the rivet torsion force of the thermostat. The multi-layer metal construction of the terminal exhibits improved bending strength and high temperature resistance to reduce the terminal heat rise of the thermostat.

### CROSS-REFERENCE TO RELATED APPLICATIONS

This application claims the benefit and priority of China utility model application no. CN 2021205865997, filed Mar. 23, 2021. The entire disclosure of the above application is incorporated herein by reference.

### FIELD

The present disclosure relates to the technical field of temperature sensors and temperature controllers.

### BACKGROUND

This section provides background information related to the present disclosure which is not necessarily prior art.

In the prior art, thermostat terminals are attached to thermostat housings by circular rivets disposed in circular rivet holes. Since they are circular structures, there will be a torsion force acting on the rivets during installation, and the rivets and the rivet holes will slide and loosen relative to each other, thereby causing the entire temperature controller structure to become loose and exhibit poor electrical contact.

In addition, brass terminals and steel terminals are widely used in the electrical connection of thermostats. Brass terminals have low bending strength and cannot withstand high temperatures. Steel terminals have low deformation but that can easily lead to loosening of the terminals connections. When riveted, its high resistivity will cause the heat of the terminal to increase, resulting in poor performance of the thermostat.

### SUMMARY

This section provides a general summary of the disclosure and is not a comprehensive disclosure of its full scope or all of its features.

The disclosure provides a construction for a high-current thermostat including a thermostat housing, a rivet hole arranged in the thermostat housing, and a rivet matched with the rivet hole. The terminal is connected to the thermostat housing by the rivet. The rivet hole and rivet each can have a polygonal shape and the rivet can be solid. The terminal can include a multi-layered metal structure. The polygonal-shaped rivet hole and solid rivet improve the rivet torsion force of the thermostat. The multi-layer metal construction of the terminal exhibits improved bending strength and high temperature resistance of the terminal.

One aspect of the present disclosure provides a thermostat, including a thermostat housing, a rivet hole arranged on the thermostat housing, a rivet matched with the rivet hole, and a terminal connected with the rivet. The rivet hole is polygonal, and the rivet is polygonal.

In another aspect of the present disclosure, the rivet hole is an octagonal rivet hole.

In another aspect of the present disclosure, the rivet is a solid rivet.

In another aspect of the present disclosure, the material of the thermostat housing is ceramic or phenolic plastic.

In another aspect of the present disclosure, the terminal includes a multi-layer metal construction.

In another aspect of the present disclosure, the terminal can bent into a preset angle X, wherein 0°≤X<180°.

In another aspect of the present disclosure, the thermostat terminal is can include at least two layers in a multi-layer metal construction.

In another aspect of the present disclosure, the terminal can be a two-layer metal construction, wherein one layer is made of steel and the other layer is made of copper.

In another aspect of the present disclosure, the terminal can be a three-layer metal construction, wherein two outer layers are made of steel and an inner layer between the two outer layers is made of copper.

The present disclosure adopts a polygonal rivet, a multi-layer metal terminal and a solid rivet. Compared to round rivets, polygonal rivet holes and rivets improve the thermostat's rivet torsion.

The terminal's multi-layer metal construction provides different layers of metal materials that form the terminal body. The terminal exhibits improved bending strength and high temperature resistance. Solid rivets have better rivet twisting force and reduce the heat rise of the terminal.

Other advantages, objects, and features of the present invention will be manifested in part by the description below, and in part will be understood by those skilled in the art from the study and practice of the present invention.

### DRAWINGS

In order to more clearly illustrate the embodiments of the present invention or the technical solutions in the prior art, the following briefly introduces the accompanying drawings that need to be used in the description of the embodiments or the prior art. The drawings described herein are for illustrative purposes only of selected embodiments and not all possible implementations are provided. The drawings are not intended to limit the scope of the present disclosure.

FIG. 1 shows a front view of a thermostat housing according to an embodiment of the present disclosure;

FIG. 2 shows a cross-sectional right side view taken along the line 2-2 of the thermostat housing of FIG. 1;

FIGS. 3A and 3B shows a front views of rivets according to the present disclosure;

FIG. 4 is a front view of a terminal according to an embodiment of the present disclosure;

FIG. 5 is a bottom view of a first exemplary embodiment of a terminal according to the present disclosure; and

FIG. 6 is a bottom view of a second exemplary embodiment of a terminal according to the present disclosure.

Corresponding reference numerals indicate corresponding parts throughout the several views of the drawings.

### DETAILED DESCRIPTION

The present disclosure will be further described in detail below with reference to the accompanying drawings, so that those skilled in the art can refer to the text of the description to implement it accordingly.

The technical solutions of the present disclosure will be described below with reference to the accompanying drawings.

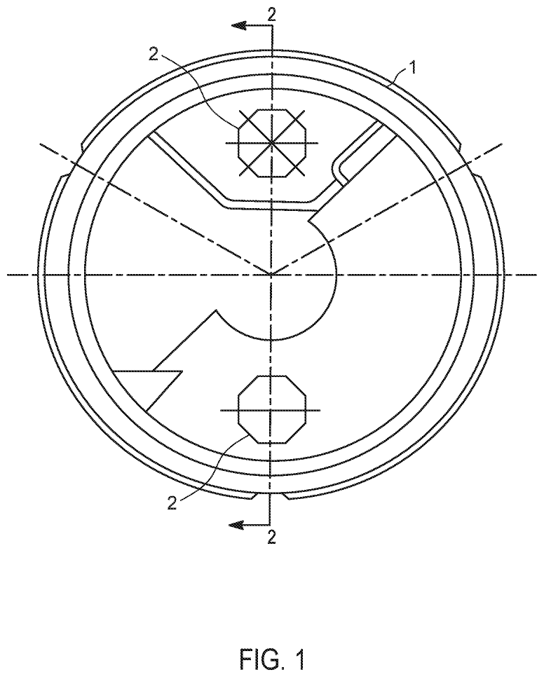

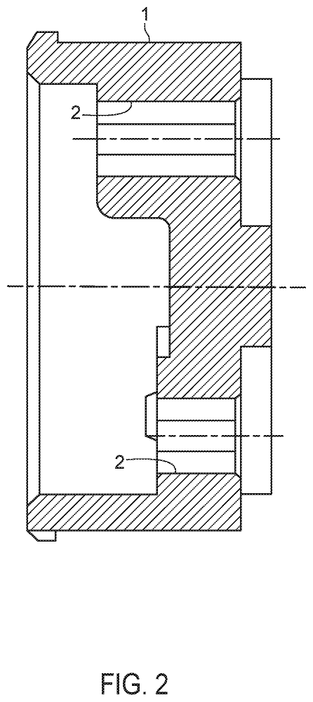

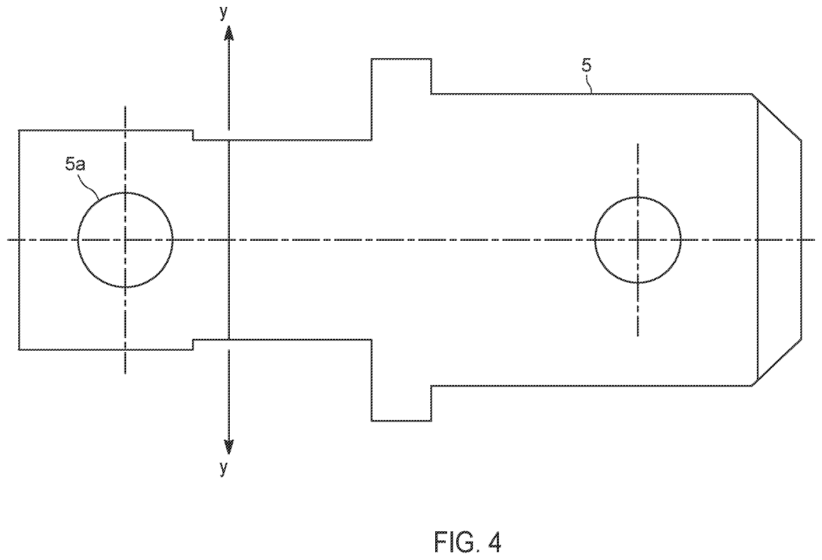

As shown in FIGS. 1, 2, 3 and 4, an embodiment of a thermostat according to the present disclosure is provided. The thermostat includes a thermostat housing 1, a rivet hole 2 provided on the thermostat housing 1, and a rivet 6 matching the rivet hole 2 and a terminal 5 attached to the housing with the rivet 6. As is understood, the terminal 5 is connected to the thermostat housing 1 by the rivet 6. The rivet hole 2 is polygonal-shaped, and the rivet 6 is polygonal-shaped to match the rivet hole 2.

Optionally, in the embodiment provided by the present disclosure, the rivet hole 2 has an octagonal shape, which can effectively improve the friction force of the rivet 6 in the rivet hole 2.

It should be noted that an octagonal rivet hole is a preferred embodiment of the present disclosure, however the polygonal-shaped rivet hole can also take the form of a quadrilateral rivet hole, a pentagonal rivet hole, a hexagonal rivet hole, a decagon rivet hole, etc. according to the application environment.

Optionally, in the embodiment provided by the present disclosure, the rivet 6 is a solid rivet. Solid rivets have higher strength than semi-hollow rivets, are difficult to loosen, and can reduce the heat rise of the terminal. Further, the solid rivet can be a solid brass rivet.

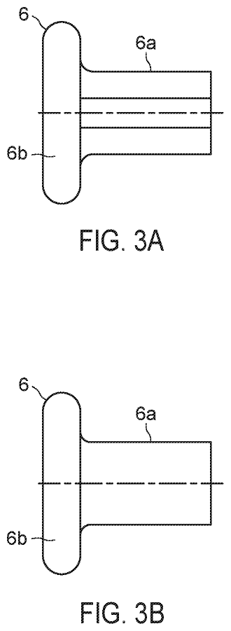

As understood with reference to FIG. 3A, it is contemplated that the rivet, in its pre-installed condition, can have a size and shape matched to fit the rivet hole. In this respect, the rivet can have a polygonal-shaped shaft 6a. For example, the rivet shaft 6a can take the form of a quadrilateral, a pentagonal, a hexagonal, an octagonal, a decagon, etc. Alternatively, as understood with reference to FIG. 3B, the rivet can, in its pre-installed condition, have a cylindrically-shaped shaft 6b that, during installation (i.e., riveting), is deformed to conform to the size and shape of the rivet hole (e.g., a cylindrical shaft can be plastically deformed to the corresponding polygonal shape of the rivet hole 2). In either case, the resulting polygonal-shaped rivet installed in a polygonal-shaped rivet hole can further improve the hold force between the rivet and the rivet hole 2 and, hence, the terminal 5 to the thermostat housing 1. This can effectively prevent the terminal 5 from being damaged. Also, because twisting and loosening of the terminal 5 can occur under a torsion force in conventional connections, the polygonal-shape rivet hole and rivet improves resistance to torsion and the reliability of riveting and the thermostat, generally.

By analyzing rivet torsion test data for thermostats with different shapes of rivet holes and rivets, polygon-shaped rivet holes and rivets performed better than circular-shaped rivet holes and rivets. Octagonal rivet holes and octagonal-shaped, solid rivets increased torque resistance for rivets and terminals from 3.5 lbs/in (for circular-shaped, half-hollow rivets) to 6.5 lb/in (for octagonal-shaped, solid rivets).

Optionally, in the embodiment provided by the present disclosure, the material of the thermostat housing 1 is a ceramic or phenolic plastic material.

The thermostat includes at least one terminal 5. The terminal 5 includes an aperture 5a that enables the rivet 6 to attach the terminal 5 to the thermostat housing 1. The aperture 5a can take any shape to accommodate the rivet 6 passing through the aperture 5a, including a circular shape or a polygonal shape that matches the shaft 6a, 6b of the rivet 6.

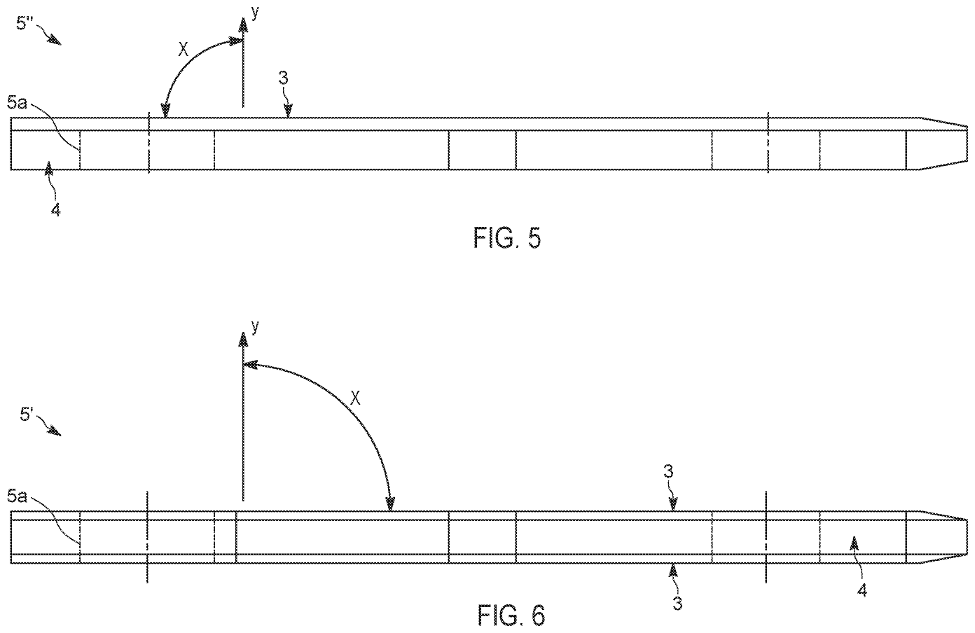

The terminal can be bent into a preset angle X, where 0°≤X<180°. The angle X is measured from the axis Y, as best seen in FIG. 5.

As shown in FIGS. 5 and 6, the present disclosure provides that, the terminal 5 is a multi-layer metal construction that can include at least two layers of a multi-layer metal construction.

As shown in FIG. 5, the terminal 5′ provided by one embodiment of the present invention is a two-layer metal construction, which is a composite terminal formed by pressing a metal layer made of copper material 4 and a metal layer made of steel material 3. In this embodiment, the steel layer 3 has better temperature resistance, and the copper layer 4 has a lower resistance value, so that the temperature resistance is improved and the electrical resistance value is small. In some application environments that have corresponding requirements for temperature resistance and electrical resistance, it has better application results.

As shown in FIG. 6, the terminal 5″ provided by another embodiment of the present invention has a three-layer metal construction, which is a composite terminal formed by pressing together a steel material metal layer 3—a copper material metal layer 4—and a steel material metal layer 3. In the terminal 5 in this embodiment, the steel layers 3 are on both sides of the copper layer 4. The steel layers 3 have better temperature resistance, thereby improving the temperature resistance of the terminal 5. Therefore, in some application environments that have higher requirements on temperature resistance, the terminal 5″ can meet the corresponding requirements and have better application effects.

Comparing the terminal bending of different composite material constructions, heating materials, the performance of multi-layer metal materials is better than that of single-layer metal materials. The bending strength is increased from 3.5 kgf (single layer) to 9 kgf (double layer), and the high temperature resistance is increased from 160° C. (single layer)) to 400° C. (three layers), the rivet torque increased from 3.6 lb/in (semi-hollow) to 6.5 lb/in (solid).

It should be noted that, this is only used as an example, and is not used as a limitation to the present application, and those skilled in the art can use alloys in related technologies to manufacture terminals according to actual needs.

Although embodiments of the present invention have been disclosed above, they are not limited to the applications listed in the specification and embodiments. It can be completely applied to various fields suitable for the present invention. Additional modifications can readily be implemented by those skilled in the art. Therefore, the invention is not limited to the specific details and illustrations shown and described herein without departing from the general concept defined by the claims and the scope of equivalents.

1. A thermostat comprising a thermostat housing, a rivet hole provided through the thermostat housing, a rivet disposed in the rivet hole, and a terminal connected to the thermostat housing with the rivet;
wherein the rivet hole is a right polygonal prism-shaped opening through the housing;
wherein the rivet comprises a rivet head and a rivet shaft;
wherein, in an uninstalled condition, the rivet shaft is a right polygonal prism sized to closely fit the rivet hole;
wherein the material of the thermostat housing is one of ceramic or phenolic plastic; and
wherein the terminal is a multi-layer metal construction.

2. The thermostat according to claim 1, wherein the rivet hole is a right octagonal prism-shaped opening through the housing.

3. The thermostat according to claim 1, wherein the rivet shaft is a solid a right polygonal prism.

4. The thermostat according to claim 1, wherein the terminal is bent into a preset angle X, wherein 0°≤X<180°.

5. A thermostat as claimed in claim 4, wherein the terminal comprises at least a two-layer metal construction.

6. The thermostat according to claim 5, wherein the terminal is a two-layer metal construction; and
wherein a first layer of the two-layer metal construction comprises steel; and
wherein a second layer of the two-layer metal construction comprises copper.

7. The thermostat according to claim 5, wherein the terminal is a three-layer metal construction having a first outer metal layer, a second outer metal layer and a third metal layer disposed between the first outer metal layer and the second outer metal layer;
wherein both the first outer metal layer and the second outer metal layer comprise steel and the third metal layer comprises copper.

8. A high-current thermostat comprising:
a thermostat housing made from an electrically insulating and thermally insulating material;
a rivet hole in the thermostat housing comprising a right octagonal prism-shaped opening through the housing;
a brass rivet comprising a head and a shaft;
wherein, in an uninstalled condition, the rivet shaft comprises a solid octagonal prism sized to closely fit the rivet hole, the rivet shaft being disposed in the rivet hole;
a terminal connected to the thermostat housing by the rivet;
wherein the terminal comprises a multi-layered metal structure including at least two metal layers, wherein a first metal layer comprises steel and a second metal layer comprises copper.

9. The high-current thermostat according to claim 8, wherein the terminal comprises a three-layer metal construction having a first outer metal layer, a second outer metal layer and a third metal layer disposed between the first outer metal layer and the second outer metal layer;
wherein both the first outer metal layer and the second outer metal layer comprise steel and the third metal layer comprises copper.

10. (canceled)
